(19) United States
(12) Patent Application Publication
(10) Pub. No.: US 2024/0020939 A1
(43) Pub. Date: Jan. 18, 2024

(54) PRECISION PLACEMENT OF PERSISTENT VIRTUAL CONTENT

(71) Applicant: EMED LABS, LLC, Miami, FL (US)

(72) Inventor: John Andrew Sands, Weston, FL (US)

(21) Appl. No.: 18/354,567

(22) Filed: Jul. 18, 2023

Related U.S. Application Data
(60) Provisional application No. 63/368,697, filed on Jul. 18, 2022.

(51) Int. Cl. G06T 19/20; G06V 20/52; G06T 5/20

(52) U.S. Cl. CPC G06T 19/20; G06V 20/52; G06T 5/20; G06T 2219/2004; G06T 2219/2016

(57) ABSTRACT

Systems, methods, and devices associated with the precise manipulation and placement of virtual content/objects in virtual space are disclosed herein. In some embodiments, user input data associated with placement of virtual content in a virtual space can be filtered/transformed across one or more degrees of freedom of the coordinate system associated with the virtual space. The filters/transforms may add precision to placement of the virtual content. The user input data can continually be monitored to detect an indication that the virtual content is close to a target location/orientation in the virtual space, and filters/transforms may be adjusted or applied to provide the user with additional precision and control over placement of the virtual content.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57.

This application claims the benefit of U.S. Provisional Patent Application No. 63/368,697, entitled “PRECISION PLACEMENT OF PERSISTENT VIRTUAL CONTENT,” filed Jul. 18, 2022, the contents of which are incorporated by reference herein in their entirety.

### TECHNICAL FIELD

The embodiments of the disclosure generally relate to the precise manipulation and placement of virtual content in virtual space. It is applicable to various extended reality (XR) technologies and applications, including those utilizing augmented reality (AR), virtual reality (VR), mixed reality (MR), and the like.

### BACKGROUND

Extended reality (XR) technologies and applications are increasing in popularity and usage. However, humans often struggle with manipulating virtual objects with a level of accuracy and precision that is needed for correctly placing and orienting digital objects in a virtual space. This can lead to significant problems, such as noticeable misalignments or unexpected behaviors in applications that may expect proper placement. The result is a loss of immersion and a poor overall user experience.

Accordingly, there exists a need for configuring extended reality (XR) technologies and applications to provide users with precise manipulation and placement of virtual content in virtual space.

### SUMMARY

For purposes of this summary, certain aspects, advantages, and novel features are described herein. It is to be understood that not necessarily all such advantages may be achieved in accordance with any particular embodiment. Thus, for example, those skilled in the art will recognize the disclosures herein may be embodied or carried out in a manner that achieves one or more advantages taught herein without necessarily achieving other advantages as may be taught or suggested herein.

All of the embodiments described herein are intended to be within the scope of the present disclosure. These and other embodiments will be readily apparent to those skilled in the art from the following detailed description, having reference to the attached figures. The invention is not intended to be limited to any particular disclosed embodiment or embodiments.

The embodiments of the disclosure generally relate to systems, methods, and devices that can provide users with additional accuracy and precision in the manipulation and placement of virtual content in virtual space. They can be used for various extended reality (XR) technologies and applications, including those utilizing augmented reality (AR), virtual reality (VR), mixed reality (MR), and the like.

In some embodiments, user input data associated with placement (e.g., location and/or orientation) of virtual content may be captured or received. For example, a user may use an input device to select an instance of virtual content within an XR application and attempt to precisely place that content in virtual space. The virtual space may be associated with a coordinate system having one or more degrees of freedom.

In some embodiments, the user input data can be filtered and/or transformed to provide the user with addition precision in placement of the virtual content. Examples of such filters and/or transforms may include low-pass filters, dynamic scalars, and the like. The filters and/or transforms may be applied to the user input data across one or more degrees of freedom.

In some embodiments, the user input data may be continually monitored to detect an indication that the virtual content is close to a target location/orientation in the virtual space. For example, the user input data may be monitored to detect a change in user behavior or the nature of user inputs (e.g., a reduction in translational or rotational movement of the virtual content, holding movement static in one or more degrees of freedom, and so forth). In some embodiments, the indication may be more explicit (e.g., the user could press button, make a hand gesture, and so forth).

In some embodiments, filters/transforms may be adjusted or applied to account for the virtual content being close to the target location/orientation and to provide the user with additional precision and control over placement of the virtual content. For example, certain movements of the virtual content may be limited/restricted, user input sensitivity could be adjusted or rescaled, and so forth.

In some embodiments, once a user has finalized their placement of the virtual content (e.g., the virtual object is now in their desired location and orientation), the user may provide or communicate an activation intent to lock or restrict movement of the virtual content, thereby fixing or “freezing” the virtual content in virtual space. This may reduce the likelihood that errors in placement are introduced during the activation process or the virtual content is moved by accident.

In some embodiments, XR applications can use cues from the user to filter user inputs. In some embodiments, a system can apply dynamic scalars to a user's inputs to adjust the sensitivity of the system to manipulations. For example, a dynamic scalar can be applied to a particular axis of manipulation, thereby adjusting sensitivity to manipulation. In some embodiments, a scalar may be applied to all degrees of freedom or to a subset of degrees of freedom, for example along a single axis.

In some cases, the embodiments disclosed herein may be used to provide users of a telehealth proctoring platform with additional accuracy and precision in the manipulation and placement of virtual content in virtual space. For instance, the telehealth proctoring platform may connect users with proctors in virtual proctoring sessions (e.g., a live audio/video stream), during which a proctor may provide instructions or guidance to a user as they self-administer a medical procedure or medication, perform a medical diagnostic test (e.g., a lateral flow test), check-in for a medical treatment plan or health improvement regimen, and so forth. Instructions or guidance for these tasks can also be provided to the user through XR technologies and applications, such as an AR/VR experience. For example, AR can be used to provide overlays that identify diagnostic test components or describe steps of diagnostic test procedure, AR can be used to provide overlays identifying a target injection site on the user's body (e.g., where the user should inject a medication), and so forth. These applications may require that users to manipulate or place virtual content, and the embodiments disclosed herein may allow users to do so accurately and precisely. Accordingly, the telehealth proctoring platform would be able to provide better service and improved patient outcomes, in a way that is impossible for traditional medical paradigms.

### BRIEF DESCRIPTION OF THE DRAWINGS

These and other features, aspects, and advantages of the disclosure are described with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIG. 1 shows an example coordinate system and degrees of freedom, in accordance with some embodiments disclosed herein.

FIG. 2 shows an illustration of filtering applied to user input data, in accordance with some embodiments disclosed herein.

FIG. 3 shows an example process for placing virtual objects, in accordance with some embodiments disclosed herein.

FIG. 4 presents a block diagram illustrating an embodiment of a computer hardware system configured to run software for implementing one or more embodiments of the systems and methods disclosed herein.

### DETAILED DESCRIPTION

Although several embodiments, examples, and illustrations are disclosed below, it will be understood by those of ordinary skill in the art that the inventions described herein extend beyond the specifically disclosed embodiments, examples, and illustrations and includes other uses of the inventions and obvious modifications and equivalents thereof. Embodiments of the inventions are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Virtual reality (VR) may refer to a simulated experience of an artificial digital environment that provides complete immersion. In some cases, VR technology may provide a user with freedom of movement within the virtual world. In advanced cases, VR technology may employ pose tracking and 3D near-eye displays to further provide the user with an immersive feel of the virtual world.

Augmented reality (AR) may refer to an interactive experience that combines the real world and computer-generated content. The content can span multiple sensory modalities, including visual, auditory, haptic, somatosensory and olfactory. AR can be defined as a system that incorporates three basic features: a combination of real and virtual worlds, real-time interaction, and accurate 3D registration of virtual and real objects. The overlaid sensory information can be constructive (i.e. additive to the natural environment), or destructive (i.e. masking of the natural environment). This experience is seamlessly interwoven with the physical world such that it is perceived as an immersive aspect of the real environment. Thus, augmented reality alters one's ongoing perception of a real-world environment, whereas virtual reality completely replaces the user's real-world environment with a simulated one.

Mixed reality (MR), sometimes referred to as hybrid reality, may create an experience combining both real-world and digital objects, which interact. Virtual content is not only overlaid on the real environment (as in AR) but is anchored to and interacts with that environment. For example, a virtual object is aware of elements in the real world like table, trees, etc. In mixed reality, a user may be able to see virtual objects similarly as in augmented reality, but these objects can also interact with the real world.

As used herein, extended reality (XR) is a catch-all term used to refer to any technology intended to combine or mirror the physical world with a “digital twin world” that a user can interact with, and it can include augmented reality (AR), virtual reality (VR), mixed reality (MR), and the like.

As used herein, extended reality (XR) space is a catch-all term used to refer to the reality/environment perceivable by the user of XR (e.g., via a display or device). The term may be used interchangeably with the term virtual space, without limitation to VR devices/technology despite inclusion of the word “virtual.”

As used herein, extended reality (XR) content is a catch-all term used to refer to any digital content rendered in the reality/environment perceivable by the user of XR. It can include digital objects, text, menus, overlays, and the like. The term may be used interchangeably with the terms virtual content or virtual object, without limitation to VR devices/technology despite inclusion of the word “virtual.”

As previously discussed, humans often struggle with manipulating virtual objects with a level of accuracy and precision that is needed for correctly placing and orienting digital objects in a virtual space. This can lead to significant problems.

For example, if an object's orientation is slightly misaligned along an axis, any subsequent child transformations that rely on the original misaligned position will also suffer from misalignment. That is, the original misalignment can propagate to subsequent transformations. If an object is relatively large and/or the misalignment is relatively large, the misalignment can be quite noticeable to a user and/or can result in unexpected behaviors in applications that may expect proper placement (or placement within a relatively narrow range of positions and/or orientations), resulting in a poor overall user experience.

Furthermore, when digital objects are not correctly placed and oriented in virtual space, it can lead to disorientation for a user or a loss of immersion; in order for augmented reality or mixed reality applications to be truly seamless, virtual content needs to be accurately and precisely placed. Incorrect placement of digital objects can be especially problematic if the application requires a high level of accuracy and precision. For example, XR environments can be used for virtual assembly purposes (e.g., assembly of piping systems), which would involve grabbing, moving, and placing many objects in specific locations and orientations (e.g., in order to couple and join the objects together). The purpose of such applications is defeated if users are unable to accurately and precisely manipulate digital objects in virtual space.

In some cases, these problems can arise because the interpretation of user input is often imperfect. For example, a touchpad can pick up accidental touches, a touchscreen can be triggered by the buildup of static electricity, computer vision systems can incorrectly interpret images or videos (causing real movements to be missed, triggering unintentional movements, etc.), and so forth. These problems can be exacerbated in XR systems because users are often inexperienced with such systems and expect that inputs (e.g., controls, hand tracking, gestures, etc.) will behave in a manner that is substantially the same as their interactions with real, physical objects, or at least in a manner that generally resembles their real-world experiences.

To address such issues, some XR systems have resorted to using digital menus (e.g., for users to specify virtual content placement) instead of direct user manipulation of the virtual content in virtual space. And some XR systems have resorted to clamping values along major axes and/or degrees of freedom (e.g., constraining an object's movement in one or more degrees of freedom) However, these approaches can have considerable drawbacks. For example, digital menus can be cumbersome to use in XR settings. Clamping can be an acceptable solution if the application developer knows an acceptable error level prior to runtime and/or can programmatically determine an acceptable error level, but this may not always be the case.

The approaches disclosed herein can be implemented in systems, methods, and devices to allow users to accurately and precisely place and orient virtual content (e.g., virtual objects, text, menus, etc.) in virtual space. For example, the approaches disclosed herein for filtering, processing, and manipulating user inputs can be implemented in a method used by an XR application to interpret user inputs received during placement of virtual content.

In some embodiments, a user may select an instance of virtual content within an XR application and attempt to precisely place that content in virtual space. As a specific example, the user may pick up a virtual object within an XR application with the intent to place the virtual object in virtual space at a specific location and in a specific orientation. In some embodiments, the virtual object can have visible text associated with it to inform the user of the virtual object's precise position (e.g., x, y, and z coordinates) and orientation (e.g., θ₁, θ₂, and θ₃) (collectively, transform values) in real-time or near real-time. The specified coordinate system and its associated degrees of freedom may affect how the position and orientation are represented. For instance, a user may pick up a virtual object within a XR application that maps out the virtual space based on the Cartesian coordinate system and six degrees of freedom (e.g., x, y, and z coordinates; and θ₁, θ₂, and θ₃ transform values), and those six parameters may be displayed right underneath the object and be continually updated as the user translates and rotates the virtual object within the virtual space.

In some embodiments, user inputs may be captured and/or received as a user manipulates the placement of virtual content in virtual space, and the user inputs may include a series of adjustments made over time in one or more of the available degrees of freedom. The user inputs may be used to adjust the recorded placement of the virtual content (e.g., to reflect the user's adjustments to the object's location and orientation as they are made in real-time) and update how the virtual content is displayed to the user (e.g., to ensure that displayed virtual content tracks the user's adjustments to maintain immersion).

In some embodiments, user inputs may be filtered and/or transformed before they are used to manipulate the placement of the virtual content in virtual space. In some embodiments, low-pass filtering may be applied to user inputs for each degree of freedom (e.g., x, y, z, θ₁, θ₂, and θ₃) or to a subset of the degrees of freedom. Low-pass filtering can be used to remove potential artifacts from the inputs that do not represent intentional input by the user. In some embodiments, the cutoff of the low pass filter can be dynamically adjusted based on the rate of change in the values received from an input device. For example, faster changes can cause the cutoff to rise (e.g., less aggressive filtering) while slower changes can cause the cutoff to fall (e.g., more aggressive filtering).

In some embodiments, dynamic scalars may be applied to user inputs along every degree of freedom or a subset of the degrees of freedom. For example, when a user changes an axis of manipulation relatively quickly, the system can be configured to limit the impact of such changes on the virtual object. Conversely, the system may scale slow movements such that they have a more significant impact on the virtual object. Preferably, the system can apply scaling that aids the user in precisely placing the virtual object while still providing the user with a responsive experience. For example, the system should preferably be configured such that the system feels responsive to the user whether the user is moving quickly or slowly.

In some embodiments, a user may change their behavior (and thus, the nature of their user inputs) as the virtual object gets close to an intended target location and/or target orientation. For instance, the user can slow down or otherwise reduce the amount of translational and/or rotational movement in their user inputs as the virtual object gets close to the target location and/or target orientation. As a specific example, a user may quickly translate and rotate a virtual object at the start, but then really slow down any translation and/or rotation of the virtual object once it is close to the target location and/or target orientation for fine tuning purposes. As another specific example, a user may initially focus on the translation of an object (e.g., its x, y, and z coordinates). However, once the virtual object is in the vicinity of the desired location, the user may begin to focus more on the transform values associated with the object and rotating the object to place it in the proper orientation. For instance, the user may hold the object in a static position (e.g., with little to no change of the x, y, and/or z coordinates) while fine tuning the orientation of the object (e.g., slowly adjusting the θ₁, θ₂, and θ₃ transform values).

In some embodiments, a user may provide some kind of detectable indication that may signal that the virtual object is close to an intended target location and/or target orientation. This indication may be communicated through or detected from any suitable form of user input and/or sensor data, and it can be provided conscious or subconsciously. For example, the aforementioned changes in user behavior and user input can be an indication (e.g., one that is subconsciously provided). Other examples could include pressing a button (e.g., a physical button on a device, a button or menu option in virtual space, etc.), making a hand gesture (e.g., a pinch/magnification gesture to signify the desire for more fine-tuned placement), a voice signal or command, and so forth.

In some embodiments, an artificial intelligence (AI) algorithm may be used to determine that the virtual object is close to the intended target location and/or target orientation. For example, during placement of a virtual object, an artificial intelligence algorithm may be used to recognize and detect a change in user behavior. Or it may continually monitor user input to detect an indication provided by the user that likely specifies that the virtual object is close to an intended target location and/or target orientation. In some embodiments, a machine learning model can be trained and applied for the purpose of recognizing and detecting this change in user behavior or this indication provided by the user.

In some embodiments, once it is determined that the virtual object is close to a target location and/or target orientation, an AI algorithm may be used to apply various filters and/or transforms to the user input, which can help the user to more precisely and/or accurately position or orient the virtual object in virtual space. In some embodiments, once it is determined that the virtual object is close to a target location and/or target orientation, an AI algorithm may adjust the parameters of the filters and/or transforms applied to the user input to help the user more precisely and/or accurately position or orient the virtual object in virtual space.

In some embodiments, once a user has finalized their placement of an instance of virtual content (e.g., the virtual object is now in their desired location and orientation), the user may provide or communicate an activation intent. The activation intent may be any suitable indication from the user that they wish to place the instance of virtual content or fix its location/orientation in virtual space. The activation intent may be communicated to the system through any suitable type of user input or sensory data. There may be one or more predetermined “activation activities” that a user may perform to provide activation intent. For example, a user may be able to press a button (e.g., a physical button on a device, or a virtual button in virtual space), make a hand gesture, change eye gaze, blink, make an auditory signal (e.g., say “done” or “finished”), and so forth.

In some embodiments, once it is determined that the placement of an instance of virtual content has been finalized (e.g., an activation intent has been detected), the virtual content may become locked or fixed in the virtual space. For instance, the system can freeze the axis of manipulation to prevent or limit further movement of the virtual content. This may reduce the likelihood that errors in placement are introduced during the activation process or the virtual content is moved by accident.

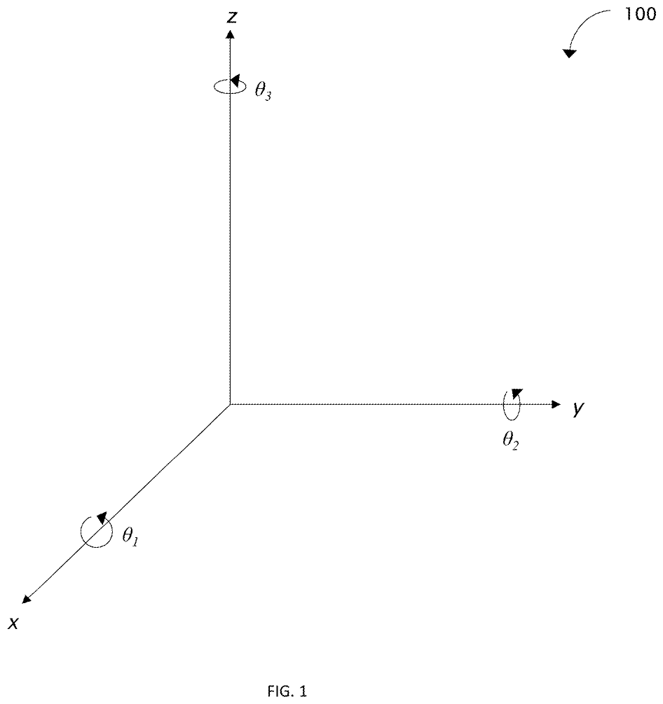

Now turning to the figures, FIG. 1 shows an example coordinate system and degrees of freedom, in accordance with some embodiments disclosed herein. More specifically, FIG. 1 shows an example system 100 with three translational and three rotational degrees of freedom. It will be appreciated that other coordinate systems can be used, for example a left-handed system, a system in which angles are measured from different directions, a system that uses spherical coordinates, cylindrical coordinates, etc. In some embodiments, the coordinate system can be chosen based in part on properties of the object being manipulated.

In some embodiments, the coordinate system and the degrees of freedom may help define the various dimensions or parameters of an object that can be manipulated (e.g., translation, rotation, etc.) in virtual space. For example, the example system 100 may be associated with a Cartesian coordinate system for a three-dimensional space, with three translational and three rotational degrees of freedom. Thus, translation of an object can be represented by three numbers (e.g., changes in the x, y, and z coordinates) and rotation of the object can also be represented by three numbers (e.g., changes in θ₁, θ₂, and θ₃ rotation around the three Cartesian coordinate axes). In some embodiments, each degree of freedom may correspond to an axis of manipulation.

In some embodiments, user input data associated with the placement of virtual content may also be based on the coordinate system and the degrees of freedom. For instance, the specified coordinate system and its associated degrees of freedom may affect how the position and orientation of a piece of virtual content is represented. For instance, a user may place a piece of virtual content with the example system 100 and its six degrees of freedom (e.g., x, y, and z coordinates; and θ₁, θ₂, and θ₃ transform values) by changing those six parameters. In some embodiments, these six parameters may be automatically adjusted as the user translates and rotates the virtual object within the virtual space. Accordingly, in some embodiments, user inputs may include a series of adjustments made over time across one or more of the available degrees of freedom.

In some embodiments, raw user inputs may be filtered and/or transformed before they are used to manipulate the placement of the virtual content in virtual space. These filters and/or transforms may be applied to user inputs for each degree of freedom (e.g., x, y, z, θ₁, θ₂, and θ₃) or to a subset of the degrees of freedom. Some examples of these filters and/or transforms include the use of low-pass filtering and dynamic scalars.

In some embodiments, low-pass filtering can be used to remove potential artifacts from the inputs that do not represent intentional input by the user. In some embodiments, the cutoff of the low pass filter can be dynamically adjusted based on the rate of change in the values received from an input device. For example, faster changes can cause the cutoff to rise (e.g., less aggressive filtering) while slower changes can cause the cutoff to fall (e.g., more aggressive filtering).

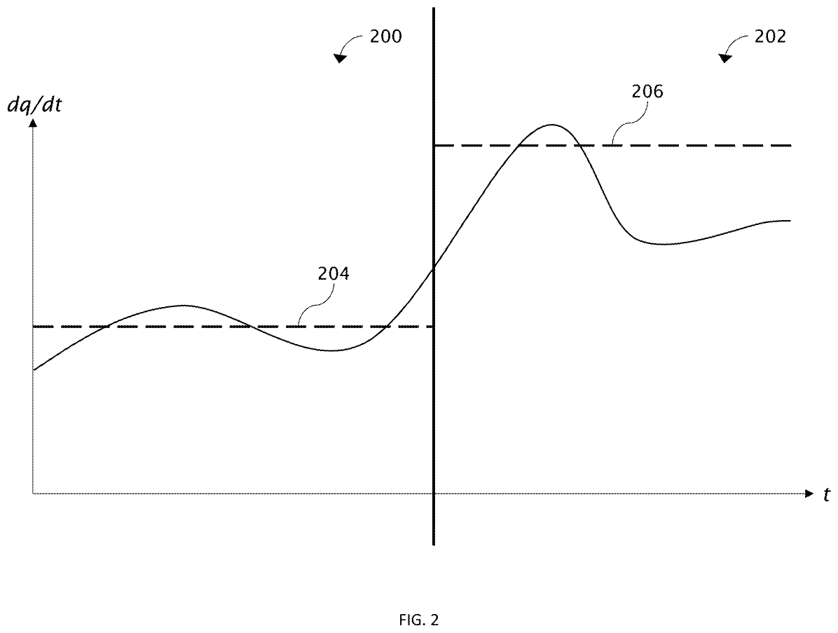

FIG. 2 shows an example of low pass filtering, according to some embodiments.

In a first region 200, the rate of change dq/dt (where q is a degree of freedom, e.g., x, y, z, θ₁, θ₂, and θ₃) can be relatively small, and the low pass filter can have a relatively low first filter level 204. When the rate of change dq/dt exceeds the first filter level, a system can be configured to ignore the motion or to limit the rate of change to the first filter level. In a second region 202, the rate of change dq/dt can be relatively large, and the second filter level 206 can be relatively large. As with the first filter level, when the rate of change exceeds the second filter level 206, the system can be configured to disregard the motion or to limit the rate to the second filter level 206. In some embodiments, a system can be configured to dynamically adjust the filter level. In some embodiments, a system can change the filter level immediately in response to the rate of change crossing a threshold value (e.g., the vertical axis dq/dt can be divided into a plurality of zones with different filtering levels associated therewith). In some embodiments, the system can be configured to adjust the filter level after the rate of change has been above or below a threshold value for a threshold amount of time. For example, a system can be configured to require that the rate of change be in a particular zone for one second, two seconds, five seconds, ten seconds, and so forth. Advantageously, filter levels, time thresholds, zones, and so forth can be configured so that the system feels responsive to the user while still helping with precision placement of objects.

In some embodiments, dynamic scalars may be similarly applied to a user's inputs along every degree of freedom or a subset of degrees of freedom. For example, when a user changes an axis of manipulation relatively quickly, the system can be configured to limit the impact of such changes on the virtual object. Conversely, the system may scale slow movements such that they have a more significant impact on the virtual object. Preferably, the system can apply scaling that aids the user in precisely placing the virtual object while still providing the user with a responsive experience. For example, the system should preferably be configured such that the system feels responsive to the user whether the user is moving quickly or slowly.

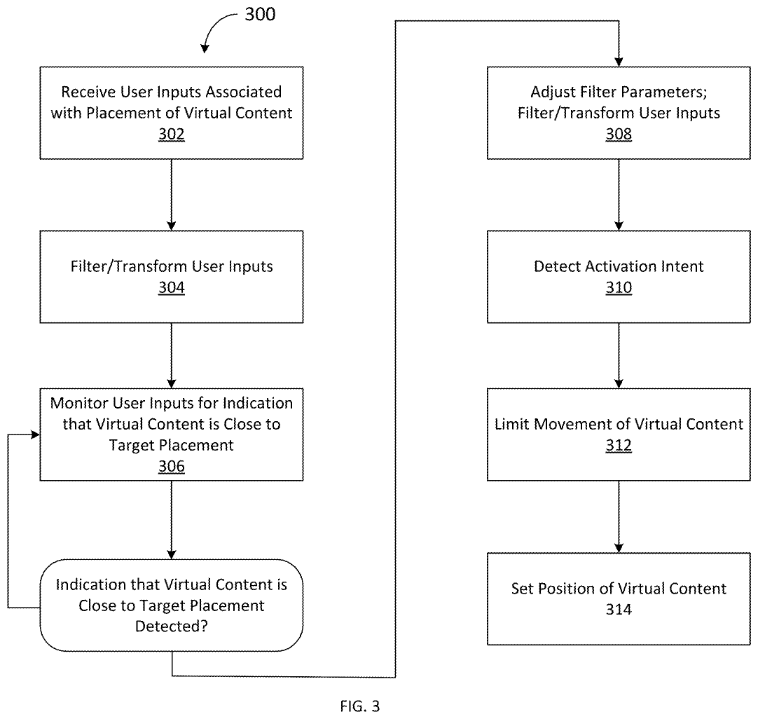

FIG. 3 shows an example process for placing virtual objects, in accordance with some embodiments disclosed herein. More specifically, FIG. 3 is a flow chart of an example process 300. In some embodiments, the process 300 can include fewer steps or additional steps, and/or steps can be performed in an order different from the order shown in FIG. 3.

Beginning at block 302, the system may receive user inputs associated with placement of an instance of virtual content. These user inputs may be captured/provided via an input device, such as a touchscreen, a controller, a mouse/keyboard, a camera with eye-tracking capability, and so forth. For example, a user may be looking to place a virtual object in virtual space and may provide user inputs directed to its placement. In some embodiments, these user inputs may include a series of adjustments made over time in one or more of the available degrees of freedom.

At block 304, the system may filter and/or transform the raw user inputs. In some embodiments, user inputs may be filtered and/or transformed before they are used to manipulate the placement of the virtual content in virtual space. In some embodiments, low-pass filtering may be applied to user inputs for each degree of freedom (e.g., x, y, z, θ₁, θ₂, and θ₃) or to a subset of the degrees of freedom, to remove potential artifacts from the inputs that do not represent intentional input by the user. In some embodiments, the cutoff of the low pass filter can be dynamically adjusted based on the rate of change in the values received from an input device. In some embodiments, dynamic scalars may be applied to user inputs along every degree of freedom or a subset of the degrees of freedom. The scalars may be used to scale the values of the raw user inputs and/or the changes to the content's placement over time (e.g., slow down quick/jerky changes in placement, speed up slow changes in placement, etc.), such as to aid the user in precisely placing the virtual content while still providing the user with a responsive experience. In some embodiments, these processed user inputs may be used to update how the virtual content is displayed to the user (e.g., by rendering it at an updated location and/or orientation in virtual space based on the processed user inputs).

At block 306, the system may continually monitor user inputs to detect an indication that the virtual content is near the intended target placement (e.g., the user's desired location and/or orientation for the virtual content within the virtual space). The system may monitor the raw user inputs and/or processed user inputs. For example, the system may monitor user attention, axis of manipulation values in the user inputs, changes in user behavior or the nature of user inputs (e.g., to determine if the user slows down movements, is engaging in static focus, etc.), and so forth.

Once it is determined that the virtual content is near the target placement, at block 308, the system may adjust the parameters of the filters and/or transforms being applied to the user input. For example, the system may adjust a filter cutoff (e.g., a low-pass filter level) and/or adjust scalars being applied to the user inputs. The system may also apply new filters and/or transforms to the user input to user inputs for each degree of freedom (e.g., x, y, z, θ₁, θ₂, and θ₃) or to a subset of the degrees of freedom. The purpose of adjusting or applying filters/transforms at this stage may be to aid the user in precisely placing the virtual content while accounting for the virtual content being near the target placement. For instance, once it is determined that the virtual content is near a target location, then filters/transforms can be adjusted or applied to remove, limit, restrict, or scale down any large translational movement of the content. Small translational movements may be allowed, and the sensitivity of user inputs can even be adjusted/rescaled to fit the range of permitted translational movement. Thus, the user may be able to focus strictly on fine-tuning the location of the content and/or adjusting the orientation.

However, additional difficulties can arise after a user has placed a virtual object in its target position. A system may be configured such that a user provides an activation to the system to indicate that the user has finished placing the object. For example, a user can press a button, make a hand gesture, change eye gaze, blink, and so forth. Often, the activation process can result in the user moving or otherwise providing inputs that can cause the virtual object to move. For example, releasing a trigger can cause unintentional input that moves the final position of the virtual object away from the target location. In some embodiments, if the system detects that the user is maintaining static focus (for example, as determined by eye tracking, user input received by an input device, hand tracking, and so forth), is maintaining a static axis of manipulation, etc., and begins one or more pre-determined activation activities (e.g., blinking, pressing a button, changing eye gaze, and so forth), the system can “freeze” the axis of manipulation to reduce the likelihood that errors in placement are introduced during the activation process.

Thus, at block 310, the system may detect placement activation or an activation intent associated with the instance of virtual content (e.g., an indication from the user that they wish to place the instance of virtual content or fix its location/orientation in virtual space). The activation intent may be communicated to the system through any suitable type of user input and/or sensor data. Thus, the system may monitor user input and/or sensor data until it detects activation intent. For example, a user can press a button (e.g., a physical button on a device, or a virtual button in virtual space), make a hand gesture, change eye gaze, blink, make an auditory signal (e.g., say “done” or “finished”), and so forth.

At block 312, upon detecting the activation intent, the system may limit movement of the virtual content in virtual space. For example, the system can freeze the axis of manipulation to prevent or limit further movement of the virtual content (e.g., fixing or “freezing” the object in virtual space).

In some embodiments, the system can be configured to monitor for a cancellation step, which can allow a user to back out of a “frozen” object scenario. The system may monitor for this indication with any suitable type of user input and/or sensor data. In some embodiments, a freeze can be canceled by, without limitation, any combination of one or more of relatively large changes in the axis of manipulation, disruption of static user attention, and an activation step (for example, a button press, verbal cue, hand gesture, etc. that is different from the placement activation).

Finally, at block 314, the system may finalize and set the position/orientation of the virtual content in virtual space.

The approaches disclosed herein can be implemented in a variety of XR technologies and applications. For example, they can be used for object tracking and imaging purposes, for the placement of virtual objects (including overlays and menus) in AR/VR, and so forth. They can be applied to other scenarios as well, such as to zooming in or out of a 2D or 3D map, changing the scale of an object, changing the aspect ratio of an object, and so forth.

Furthermore, the approaches disclosed herein may be used with telehealth proctoring platform or health testing and diagnostics platforms, which are typically used to facilitate proctored or video-based at-home or remote healthcare testing and diagnostics. For example, users performing at home testing may be guided or assisted by proctors that are available over a communication network using, for example, live video on via the users' devices. These proctors may include medical professionals (e.g., physician, nurse, nutritionist, health coach, and/or the like) that can monitor, supervise, and provide instructions or real-time guidance to the users for many different situations and contexts. For example, a proctor may be able to supervise a user performing a medical diagnostic test to verify adherence to proper test procedure, to ensure test result authenticity (e.g. that the test results have not been swapped or tampered with), or even provide suggestions or interpretations of the diagnostic test results. In another similar example, a proctor may be able to supervise a user while they self-administer a medication (e.g., inject themselves with a drug) to provide instructions and guidance on how to administer the medication correctly (e.g., the exact location the drug should be injected, the correct dosage, and so forth).

However, the use of extended reality (XR), such as augmented reality (AR) and/or mixed reality (MR), can offer many benefits for remote medical testing and supervision. In some cases, these procedures or tests may include various objects that can be processed for AR/MR. For example, these procedures or tests may involve the scanning of a test kit expiration date, user identification card view, the swabbing of the user's nostrils, opening packaging, results interpretation, etc. AR/MR can be used to assist with those tasks.

Furthermore, AR/MR can be used to provide a user with an augmented reality experience (e.g., on a user device, such as a cellphone, smartphone, tablet, laptop, personal digital assistant (PDA), or the like). The augmented reality experience can be used to assist proctors or reduce their burden, such as by guiding the user through self-administration of a diagnostic test, medical procedure, or the like. In other words, instructions or guidance for various tasks can also be provided to the user through the augmented reality experience. Thus, AR/MR can not only be used to help users properly identify and place test components, properly perform procedures or steps of procedures (for example, nasal swabbing), and so forth, but it can also be used to provide overlays that identify diagnostic test components or describe steps of diagnostic test procedure. As a specific example, AR can be used to provide overlays identifying a target injection site on the user's body (e.g., where the user should inject a medication). Additional discussion regarding target site determination is provided in U.S. Provisional Patent Application No. 63/506,046, filed Jun. 2, 2023, and entitled “SYSTEM-GUIDED TARGET SITE DETERMINATION SYSTEM USING COMPUTER VISION,” which is incorporated by reference in its entirety. These applications may require that users to manipulate or place virtual content as part of the augmented reality experience, and the embodiments disclosed herein may allow users to do so accurately and precisely.

### Computer Systems

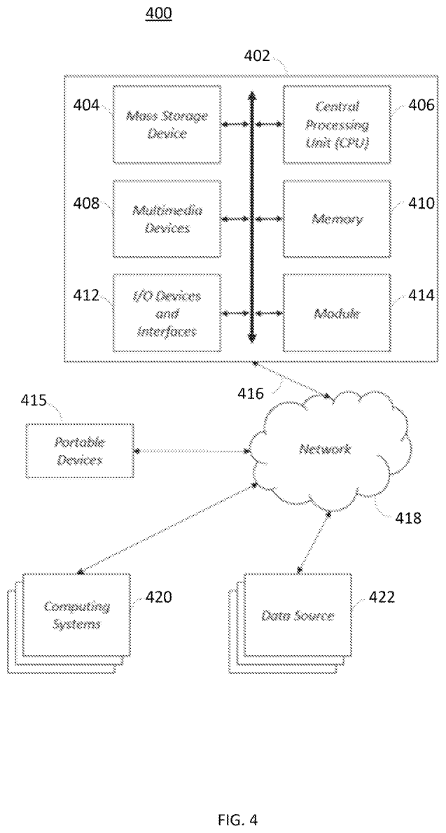

FIG. 4 is a block diagram depicting an embodiment of a computer hardware system configured to run software for implementing the approaches for virtual content placement and any systems, methods, and devices disclosed herein. The example computer system 402 is in communication with one or more computing systems 420 and/or one or more data sources 422 via one or more networks 418. While FIG. 4 illustrates an embodiment of a computing system 402, it is recognized that the functionality provided for in the components and modules of computer system 402 may be combined into fewer components and modules, or further separated into additional components and modules.

The computer system 402 can comprise a module 414 that carries out the functions, methods, acts, and/or processes described herein. The module 414 is executed on the computer system 402 by a central processing unit 406 discussed further below.

In general, the word “module,” as used herein, refers to logic embodied in hardware or firmware or to a collection of software instructions, having entry and exit points. Modules are written in a program language, such as JAVA, C or C++, PYTHON or the like. Software modules may be compiled or linked into an executable program, installed in a dynamic link library, or may be written in an interpreted language such as BASIC, PERL, LUA, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within special designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted.

The computer system 402 includes one or more processing units (CPU) 406, which may comprise a microprocessor. The computer system 402 further includes a physical memory 410, such as random-access memory (RAM) for temporary storage of information, a read only memory (ROM) for permanent storage of information, and a mass storage device 404, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 402 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 402 includes one or more input/output (I/O) devices and interfaces 412, such as a keyboard, mouse, touch pad, and printer. The I/O devices and interfaces 412 can include one or more display devices, such as a monitor, which allows the visual presentation of data to a user. More particularly, a display device provides for the presentation of GUIs as application software data, and multi-media presentations, for example. The I/O devices and interfaces 412 can also provide a communications interface to various external devices. The computer system 402 may comprise one or more multi-media devices 408, such as speakers, video cards, graphics accelerators, and microphones, for example.

The computer system 402 may run on a variety of computing devices, such as a server, a Windows server, a Structure Query Language server, a Unix Server, a personal computer, a laptop computer, and so forth. In other embodiments, the computer system 402 may run on a cluster computer system, a mainframe computer system and/or other computing system suitable for controlling and/or communicating with large databases, performing high volume transaction processing, and generating reports from large databases. The computing system 402 is generally controlled and coordinated by an operating system software, such as z/OS, Windows, Linux, UNIX, BSD, SunOS, Solaris, MacOS, or other compatible operating systems, including proprietary operating systems. Operating systems control and schedule computer processes for execution, perform memory management, provide file system, networking, and I/O services, and provide a user interface, such as a graphical user interface (GUI), among other things.

The computer system 402 illustrated in FIG. 4 is coupled to a network 418, such as a LAN, WAN, or the Internet via a communication link 416 (wired, wireless, or a combination thereof). Network 418 communicates with various computing devices and/or other electronic devices. Network 418 is communicating with one or more computing systems 420 and one or more data sources 422. The module 414 may access or may be accessed by computing systems 420 and/or data sources 422 through a web-enabled user access point. Connections may be a direct physical connection, a virtual connection, and other connection type. The web-enabled user access point may comprise a browser module that uses text, graphics, audio, video, and other media to present data and to allow interaction with data via the network 418.

Access to the module 414 of the computer system 402 by computing systems 420 and/or by data sources 422 may be through a web-enabled user access point such as the computing systems' 420 or data source's 422 personal computer, cellular phone, smartphone, laptop, tablet computer, e-reader device, audio player, or another device capable of connecting to the network 418. Such a device may have a browser module that is implemented as a module that uses text, graphics, audio, video, and other media to present data and to allow interaction with data via the network 418.

The output module may be implemented as a combination of an all-points addressable display such as a cathode ray tube (CRT), a liquid crystal display (LCD), a plasma display, or other types and/or combinations of displays. The output module may be implemented to communicate with input devices 412 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another embodiment, a user may interact with the system more directly such as through a system terminal connected to the score generator without communications over the Internet, a WAN, or LAN, or similar network.

In some embodiments, the system 402 may comprise a physical or logical connection established between a remote microprocessor and a mainframe host computer for the express purpose of uploading, downloading, or viewing interactive data and databases on-line in real time. The remote microprocessor may be operated by an entity operating the computer system 402, including the client server systems or the main server system, an/or may be operated by one or more of the data sources 422 and/or one or more of the computing systems 420. In some embodiments, terminal emulation software may be used on the microprocessor for participating in the micro-mainframe link.

In some embodiments, computing systems 420 who are internal to an entity operating the computer system 402 may access the module 414 internally as an application or process run by the CPU 406.

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computing system 402 may include one or more internal and/or external data sources (for example, data sources 422). In some embodiments, one or more of the data repositories and the data sources described above may be implemented using a relational database, such as DB2, Sybase, Oracle, CodeBase, and Microsoft® SQL Server as well as other types of databases such as a flat-file database, an entity relationship database, and object-oriented database, and/or a record-based database.

The computer system 402 may also access one or more databases 422. The databases 422 may be stored in a database or data repository. The computer system 402 may access the one or more databases 422 through a network 418 or may directly access the database or data repository through I/O devices and interfaces 412. The data repository storing the one or more databases 422 may reside within the computer system 402.

### Additional Embodiments

In the foregoing specification, the systems and processes have been described with reference to specific embodiments thereof. It will, however, be evident that various modifications and changes may be made thereto without departing from the broader spirit and scope of the embodiments disclosed herein. The specification and drawings are, accordingly, to be regarded in an illustrative rather than restrictive sense.

Indeed, although the systems and processes have been disclosed in the context of certain embodiments and examples, it will be understood by those skilled in the art that the various embodiments of the systems and processes extend beyond the specifically disclosed embodiments to other alternative embodiments and/or uses of the systems and processes and obvious modifications and equivalents thereof. In addition, while several variations of the embodiments of the systems and processes have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the embodiments of the disclosed systems and processes. Any methods disclosed herein need not be performed in the order recited. Thus, it is intended that the scope of the systems and processes herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every embodiment.

It will also be appreciated that conditional language used herein, such as, among others, “can,” “could,” “might,” “may,” “for example,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the embodiments are not to be limited to the particular forms or methods disclosed, but, to the contrary, the embodiments are to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (for example, as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (for example, as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

We claim:

1. A computer-implemented method for providing precise placement of virtual content, the method comprising:
receiving, from a user, first user input data associated with placement of an extended reality (XR) object in a XR space displayed to the user, wherein the XR space is associated with a coordinate system;
applying a filter to the first user input data across one or more degrees of freedom of the coordinate system;
updating, based on the filtered first user input data, placement of the XR object in the XR space displayed to the user;
monitoring the first user input data to detect an indication that the XR object is close to a target location in the XR space;
upon detecting the indication, adjusting parameters of the filter to provide the user with additional precision over placement of the XR object;
monitoring second user input data to detect an activation intent; and
upon detecting the activation intent, limiting further movement of the XR object in the XR space.

2. The computer-implemented method of claim 1, wherein the filter comprises a low-pass filter used to remove potential artifacts from the first user input data that do not represent intentional input by the user.

3. The computer-implemented method of claim 1, wherein the filter comprises a low-pass filter with a cutoff that is dynamically adjusted based on the rate of change in the values received from an input device.

4. The computer-implemented method of claim 1, wherein the filter comprises dynamic scalars applied to the first user input data across one or more degrees of freedom of the coordinate system.

5. The computer-implemented method of claim 1, wherein updating placement of the XR object in XR space comprises updating a position and an orientation of the XR object in three-dimensional space.

6. The computer-implemented method of claim 1, wherein monitoring the first user input data to detect the indication that the XR object is close to the target location comprises detecting a change in user behavior from the first user input data.

7. The computer-implemented method of claim 1, wherein monitoring the first user input data to detect the indication that the XR object is close to the target location comprises detecting a reduction in translational or rotational movement in the first user input data.

8. The computer-implemented method of claim 1, wherein monitoring the first user input data to detect the indication that the XR object is close to the target location comprises detecting, from the first user input data, a user intent to hold placement of the XR object static across one or more degrees of freedom of the coordinate system.

9. The computer-implemented method of claim 1, wherein adjusting parameters of the filter to provide the user with additional precision over placement of the XR object comprises adjusting dynamic scalars to limit any large translational movements of the XR object.

10. The computer-implemented method of claim 1, wherein adjusting parameters of the filter to provide the user with additional precision over placement of the XR object comprises adjusting a sensitivity of user inputs for placement of the XR object.

11. A non-transient computer readable medium containing program instructions for causing a computer to perform a method for providing precise placement of virtual content, the method comprising:
receiving, from a user, first user input data associated with placement of an extended reality (XR) object in a XR space displayed to the user, wherein the XR space is associated with a coordinate system;
applying a filter to the first user input data across one or more degrees of freedom of the coordinate system;
updating, based on the filtered first user input data, placement of the XR object in the XR space displayed to the user;
monitoring the first user input data to detect an indication that the XR object is close to a target location in the XR space;
upon detecting the indication, adjusting parameters of the filter to provide the user with additional precision over placement of the XR object;
monitoring second user input data to detect an activation intent; and
upon detecting the activation intent, limiting further movement of the XR object in the XR space.

12. The non-transient computer readable medium of claim 11, wherein the filter comprises a low-pass filter used to remove potential artifacts from the first user input data that do not represent intentional input by the user.

13. The non-transient computer readable medium of claim 11, wherein the filter comprises a low-pass filter with a cutoff that is dynamically adjusted based on the rate of change in the values received from an input device.

14. The non-transient computer readable medium of claim 11, wherein the filter comprises dynamic scalars applied to the first user input data across one or more degrees of freedom of the coordinate system.

15. The non-transient computer readable medium of claim 11, wherein updating placement of the XR object in XR space comprises updating a position and an orientation of the XR object in three-dimensional space.

16. The non-transient computer readable medium of claim 11, wherein monitoring the first user input data to detect the indication that the XR object is close to the target location comprises detecting a change in user behavior from the first user input data.

17. The non-transient computer readable medium of claim 11, wherein monitoring the first user input data to detect the indication that the XR object is close to the target location comprises detecting a reduction in translational or rotational movement in the first user input data.

18. The non-transient computer readable medium of claim 11, wherein monitoring the first user input data to detect the indication that the XR object is close to the target location comprises detecting, from the first user input data, a user intent to hold placement of the XR object static across one or more degrees of freedom of the coordinate system.

19. The non-transient computer readable medium of claim 11, wherein adjusting parameters of the filter to provide the user with additional precision over placement of the XR object comprises adjusting dynamic scalars to limit any large translational movements of the XR object.

20. The non-transient computer readable medium of claim 11, wherein adjusting parameters of the filter to provide the user with additional precision over placement of the XR object comprises adjusting a sensitivity of user inputs for placement of the XR object.
